(19) United States
(12) Patent Application Publication
(10) Pub. No.: US 2001/0053987 A1
(43) Pub. Date: Dec. 20, 2001

(54) Tele-health information system

(75) Inventors: Peter Kleinschmidt, Erlangen (DE); Eva Winnik, Hemhofen (DE)

Correspondence Address: Schiff Hardin & Waite, Patent Department, Sears Tower 6600 Floor, 233 South Wacker Drive, Chicago, IL, 60606, US

(73) Assignee: Siemens Aktiengesellschaft

(21) Appl. No.: 09/881,217

(22) Filed: Jun. 14, 2001

(30) Foreign Application Priority Data
Jun. 15, 2000 (DE) 10029589.4

(51) Int. Cl. G06F 17/60

(52) U.S. Cl. 705/3

(57) ABSTRACT

A tele-health information system for patient groups, particularly for members of a company, has a server, which contains the personal data and medical data of a patient and which is connected to a data input device and a data output device. The server has a variable data input device enabling an inquiry about different location-variable data request stations and different data transmission systems and has an intelligent data output device producing a data output that is adapted to the type of the data request station, or corresponding to a user request.

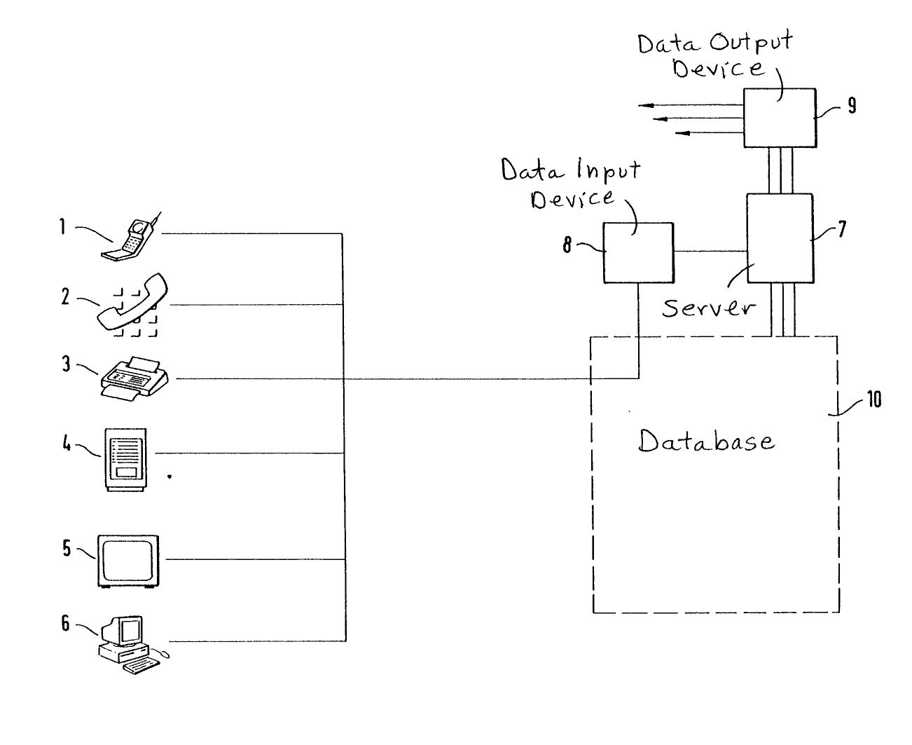

### BACKGROUND OF THE INVENTION

1. Field of the Invention

The present invention relates to a tele-health information system for patient groups, particularly for members of a company, of the type having a server, which contains the personal data and medical data of a patient and which is connected to a data input device and a data output device.

2. Description of the Prior Art

For stays in foreign countries, companies would like to equip employees with documents about their health status, such documents would be—in case of need—available to the treating physician farfrom the home country. In particular, an electronic form would have significant handling and security advantages, since it is only requested if needed. A problem is that the presence of internet computers cannot be assumed in all foreign countries. Moreover, speech barriers can make the demand more difficult.

European Patent 0 890 919 A1 describes a general data transmission system. The data transmission system is provided for transmitting bits of information exclusively in one format, specifically in the HTML format.

### SUMMARY OF THE INVENTION

An object of the invention is to provide a tele-health information device for patients of a group in a foreign country, namely particularly members of a company, which also assures the availability of the necessary medical documents and the potential help of the primary physician if a medical pathology arises at a location in a foreign country, even under primitive conditions. The current maintenance of the data ensues via a data input device operated by authorized personnel.

This object, is inventively achieved in a tele-health information system of the aforementioned type wherein the server has a variable data input device enabling an inquiry about different location-variable data request stations and different data transmission systems, and has an intelligent data output device effecting a data output that is adapted to the type of the data request station, or, corresponding to a user request.

It is assumed by the invention that at least a telephone, such as a mobile telephone of the patient, is present at the place of the medical problem in the case of need; even the presence of a fax machine can be assumed in most cases. The invention also assumes that the data are present on a secure server, mostly in the home country, and are permanently maintained (data input device). Third, an intelligent dialog component is implemented according to the present invention, which proposes step-by-step a course of action to the patient—or alternatively to persons assisting in the foreign country—, the course of action being adapted to the terminal devices (data request stations) that are available at the location. The dialog includes the acknowledgment of the patient. For this purpose, an authenticating access code, which is preferably integrated into a mobile access communication device such as the laptop or the mobile telephone of the patient, is initially allocated to each patient. For this purpose, a pin number can be provided for each patient, which is suitably entered in a written, oral or other form, in order to be identified at the server. Alternatively, the authenticating access code is stored in the personal access communication device on a chip or such, preferably such that this access code cannot be read even by the owner himself, so that falsification and abuse by a third party is completely precluded. This is preferably realized by a “smart card”, namely a chip card, which can be inserted into a mobile communication device in a similar way as a SIMM card.

The aforementioned intelligent dialog, which can be conducted by the patient after the server has been dialed and which forwards the requesting person step-by-step, can be a program that is implemented into the server, or this dialog can be conducted by an operator as well, which is dialed by the server if needed and is switched into the dialog.

In a further embodiment of the invention, the tele-health information device can be designed such that the user dialog can be optionally connected as a motor driven dialog or personal dialog in the patient's language or a different language and such that the output mode and the specific output format can be freely selected.

Moreover, the server can be coupled with an expert system, which can prepare diagnostic proposals on the basis of the previous patient data and the newly entered medical report from the foreign country.

### DESCRIPTION OF THE DRAWING

The single FIGURE is a schematic block diagram of a tele-health information system constructed and operating in accordance with the principles of the present invention.

### DESCRIPTION OF THE PREFERRED EMBODIMENTS

The personal mobile telephone 1 of the patient, a public telephone 2, a fax machine 3, a PDA 4, specifically the personal PDA of the patient, a WEB-TV 5 or the PC 6 of the physician treating in the foreign country can serve as a location-variable data request station in the foreign country for using the inventive tele-health information device. The call number or the internet address of the central server 7 in the home country, therefore predominately at the location of the company of the patient, is dialed via such a location-variable access. If the dialing patient is not automatically identified via his or her personal mobile telephone or PDA as a result of a stored authenticating access code—a pin number and the communication number of the access device must be entered, so that the server can recognize that the requesting person is authorized for access and so that the server knows where to send the bits of information. The data input device is designed such that it can process written requests and verbal requests, possibly with the intervention of a native-speaking operator. The design of the data input device 8 and of the data output device 9 is such that the data output is automatically adapted to the type of the dialing location-variable access. For example, if there has been a verbal request via a mobile telephone, the data output device 9 will provide a verbal output of the information—unless something else is explicitly requested at the verbal request—either via the native-speaking operator or via a speech generation system. Furthermore, the data are provided with a specific output format, namely a foreign language translation, for example, as a WEB page, WAP page, email, text to speech conversion, etc.

The server 7 is connected to a database 10, in which the name, address, the communication addresses of the patient and the insurance, the primary physician and all specialists, who have treated the patient earlier, are stored for each patient, as well as medical data such as the blood type, vaccinations, overcome illnesses, normal blood pressure, normal pulse, last EKG, incompatibilities, allergies, acute diseases, prescribed medication and its ingredients, etc.

Although modifications and changes may be suggested by those skilled in the art, it is the intention of the inventor to embody within the patent warranted hereon all changes and modifications as reasonably and properly come within the scope of his contribution to the art.

We claim as our invention:

1. A tele-health information system for a patient group, comprising:
a server having access to a data base containing personal data and medical data of a patient belonging to a group of patients;
a variable data input device connectable to a plurality of location-variable data request stations of different types and having different data transmission systems associated therewith, for generating data requests and user requests to said server; and
an intelligent data output device connected to said server for producing a data output from said server adapted to a type of data request station making a data request to said server or adapted to a user request to said user.

2. A tele-health information system as claimed in claim 1 wherein each patient in said group has an authenticating access code uniquely allocated thereto, and wherein one of said data request stations comprises a mobile access communication device having a patient's authenticating access code integrated therein.

3. A tele-health information system as claimed in claim 2 wherein said authenticating access code is a pin number.

4. A tele-health information system as claimed in claim 2 wherein said authenticating access code is stored in said mobile access communication device in a non-humanly readable form.

5. A tele-health information system as claimed in claim 4 wherein said authenticating access code is stored in said mobile access communication device as an electronic chip.

6. A tele-health information system as claimed in claim 1 wherein said server initiates a dialog with a patient via said data input device and one of said data request stations.

7. A tele-health information system as claimed in claim 6 wherein said dialog is an operator-assisted dialog.

8. A tele-health information system as claimed in claim 6 wherein said dialog is an automatic, intelligent dialog.

9. A tele-health information system as claimed in claim 6 wherein said dialog is conducted in a selected language.

10. A tele-health information system as claimed in claim 6 wherein an output mode and an output format at said data output device are selectable via said dialog.

11. A tele-health information system as claimed in claim 1 wherein said database contains, for each patient in said group, information selected from the group consisting of laboratory measurements, electric cardiogram data, data relating to prescribed medication, important medically-related facts, and allergies.

12. A tele-health information system as claimed in claim 11 wherein said laboratory measurements are selected from the group consisting of blood pressure, blood sugar and HbAlc.
